(19) United States
(12) Patent Application Publication
(10) Pub. No.: US 2017/0208773 A1
(43) Pub. Date: Jul. 27, 2017

(54) METHODS OF PREVENTING OR MITIGATING DISCOLORATION OF PET LITTER

(71) Applicant: NESTEC SA, VEVEY (CH)

(72) Inventor: James Li, Frontenac, MO (US)

(21) Appl. No.: 15/415,410

(22) Filed: Jan. 25, 2017

Related U.S. Application Data
(60) Provisional application No. 62/287,644, filed on Jan. 27, 2016.

(51) Int. Cl. A01K 1/015; B05D 3/10; B05D 3/00; A01K 1/01; B05D 1/22

(52) U.S. Cl. CPC A01K 1/0154; A01K 1/0107; B05D 1/22; B05D 3/007; B05D 3/104

(57) ABSTRACT

A chelating agent prevents or mitigates discoloration for clumping pet litter containing raw clay seeds coated with bentonite. The chelating agent can be added directly to the raw clay seeds and/or dry mixed with bentonite prior to coating the seeds with the bentonite. Preferably, preheating and agglomeration steps are eliminated to thereby significantly reduce energy and water consumption.

### CROSS REFERENCE TO RELATED APPLICATIONS

This application claims priority to U.S. Provisional Application No. 62/287644 filed Jan. 27, 2016, the disclosure of which is incorporated by references in its entirety.

### BACKGROUND

The present disclosure relates generally to methods of making color-stable pet litter that do not require preheating. More specifically, the present disclosure is directed to using a chelating agent to prevent or mitigate discoloration of pet litter containing raw clay seeds.

Litter boxes are used by pets such as cats for elimination of urine and fecal matter. A litter box contains a layer of pet litter that receives the urine and fecal matter. The pet litter is granular, absorbent and either non-clumping or clumping. A clumping pet litter is a litter product in which the particles facilitate formation of clumps after the urine and fecal matter is deposited in the pet litter. The clumps are typically sifted from the litter box using a litter scoop and then discarded. Non-clumping pet litter is also good at absorbing urine and thus removing urine odors, but replacing soiled non-clumping pet litter without emptying the entire box of litter is usually difficult, so consumers generally prefer clumping litters.

Existing litters include compositions made from clay minerals, silica gel, and agricultural wastes. Clay minerals are typically both absorptive and are well accepted by pets. Examples of processes for preparing clay litters are disclosed in U.S. Pat. Nos. 6,887,570; 7,958,847; 8,096,267; and 8,584,617; herein incorporated by reference in their entireties. These processes generally involve heating and/or drying of raw clay, followed by water addition to re-agglomerate the heated raw clay to make seeds. These seeds are then coated with bentonite to provide clumping properties for pet litter.

The resultant clumping litter is adequate. However, the heating/drying step consumes significant amounts of energy and water. In addition, maintenance of the manufacturing equipment can be costly.

### SUMMARY

The present disclosure relates generally to methods of making color-stable pet litter that do not require preheating. More specifically, the present disclosure is directed to preventing or mitigating discoloration of pet litter containing raw clay seeds by adding a chelating agent such as sodium tripolyphosphate. The chelating agent can be added directly to the raw clay seeds and/or dry mixed with bentonite prior to coating the seeds with the bentonite.

As noted above, adequate clumping litter can be made by heating and/or drying raw clay, followed by water addition to re-agglomerate the heated raw clay to make seeds, and then coating these seeds with bentonite to provide clumping properties for cat litter. However, the heating/drying step consumes significant amounts of energy and water, and maintenance of the manufacturing equipment can be costly. To address these issues, the present inventors eliminated the heating/drying and re-agglomeration steps, and the resultant fresh engineered litter produced using raw clay as core seeds appeared similar to litter made by the process which included heating. Nevertheless, after exposure to air this litter would discolor in a couple of days to a couple of weeks. In most cases, an orange or brown color would form on the surface of litter (see FIG. 1), and a green color was observed as well. This discoloration of litter would reduce consumer experience and acceptance of the litter.

As detailed in the experimental examples herein, the present inventors unexpectedly found that a chelating (or sequestering) method can stop or mitigate the discoloration. Without being bound by theory, the present inventors believe that the chelating agent bonds to manganese and/or other discoloring elements such that the migration of discoloring elements to the surface of the litter is stopped or reduced, thus preventing or reducing discoloration of the litter. As further detailed in the experimental examples, other mechanisms such as oxidation, neutralization and combination thereof were tested, but these other mechanisms were not effective in stopping or reducing discoloration of litter.

Accordingly, in a general embodiment, the present disclosure provides a method of making a clumping pet litter, the method comprising: coating clay particles with bentonite; and incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.

In an embodiment, the method comprises subjecting the clay particles to a sieve to obtain a subset of clay particles that have a desired size before the coating of the clay particles, and only the subset of clay particles is coated with the bentonite. The desired size can be about −10 mesh to about +50 mesh.

In an embodiment, the chelating agent is 0.01-5.0 wt. % of the clay particles coated with the bentonite.

In an embodiment, the chelating agent is selected from the group consisting of sodium tripolyphosphate (STPP), sodium pyrophosphate, ethylenediaminetetraacetic acid disodium salt, and combinations thereof. The chelating agent preferably comprises sodium tripolyphosphate (STPP).

In an embodiment, at least a portion of the chelating agent is added to the clay particles before the coating of the clay particles with the bentonite. The chelating agent added to the clay particles can be uniformly applied to the clay particles.

In an embodiment, at least a portion of the chelating agent is added to the bentonite before the coating of the clay particles with the bentonite. The chelating agent added to the bentonite can be uniformly mixed with the bentonite.

In an embodiment, the method comprises drying the clay particles coated with the bentonite to a moisture content of about 5 wt. % to about 15 wt. %. The clay particles are preferably not heated before the drying. In an embodiment, the clay particles are not re-agglomerated before the coating with the bentonite. In some embodiments, the clay particles are subjected to sizing or compacting and then sizing before the coating with bentonite.

In an embodiment, the method comprises grinding granules of the chelating agent to reduce the size thereof before adding the chelating agent to the clay particles and/or the bentonite.

In an embodiment, the coating of the clay particles with the bentonite is performed by a device selected from the group consisting of a fluidized bed dryer, a semi-continuous centrifugal coater, a rotary coating and drying system, and combinations thereof.

In another embodiment, the present disclosure provides a pet litter made by a process comprising coating clay particles with bentonite and comprising incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite. The pet litter can further comprise an additive selected from the group consisting of an odor control agent, a fragrance, an anti-microbial agent, an anti-sticking agent, an agent for controlling pH, a dye, a coloring agent, a de-dusting agent, a disinfectant, and combinations thereof.

In another embodiment, the present disclosure provides a method of managing pet waste, the method comprising positioning a pet litter in a litter box used by a pet, the pet litter made by a process comprising coating clay particles with bentonite and comprising incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite. The pet is preferably a cat.

In another embodiment, the present disclosure provides a method of preventing or mitigating discoloration of a clumping pet litter, the method comprising: coating clay particles with bentonite; and incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.

An advantage of one or more embodiments provided by the present disclosure is to improve methods of making clumping litters.

Another advantage of one or more embodiments provided by the present disclosure is to significantly reduce energy and water consumption by eliminating preheating and agglomeration steps from processes of making clumping litter from raw clay.

A further advantage of one or more embodiments provided by the present disclosure is to eliminate the preheating and agglomeration steps from processes of making clumping litter from raw clay without sacrificing the performance of the litter or the appearance of the litter.

Still another advantage of one or more embodiments provided by the present disclosure is to eliminate the preheating and agglomeration steps from processes of making clumping litter from raw clay without sacrificing acceptance of the litter by the pet or the consumer.

Additional features and advantages are described herein and will be apparent from the following Detailed Description and the Figures.

### BRIEF DESCRIPTION OF THE FIGURES

FIG. 1 shows photographs of clumping litter made by coating raw clay with bentonite without heating/drying, without re-agglomeration, and without chelating agent, before exposure to air (left photograph) and about three weeks after exposure to air (right photograph).

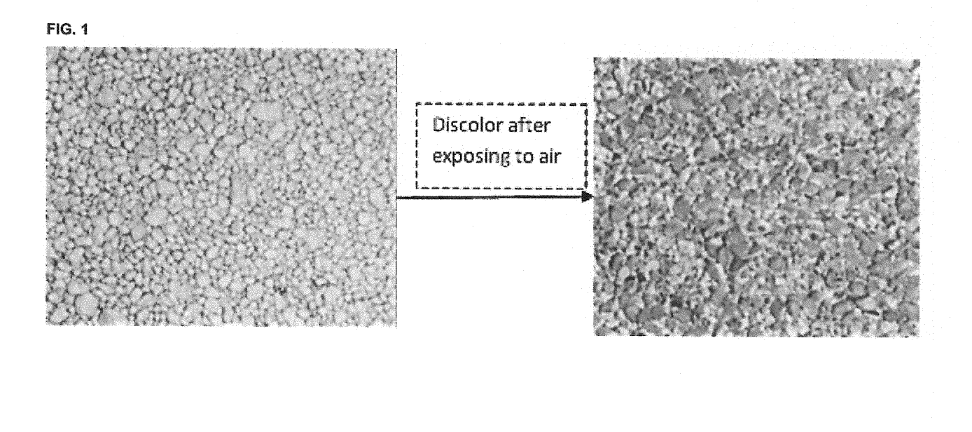

FIG. 2 shows a table of results from an experimental study disclosed herein.

FIG. 3 shows a chart of results from an experimental study disclosed herein.

FIG. 4 shows photographs of results from the experimental study.

### DETAILED DESCRIPTION

As used in this disclosure and the appended claims, the singular forms “a,” “an” and “the” include plural referents unless the context clearly dictates otherwise. Thus, for example, reference to “a material” or “the material” includes two or more materials.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

However, the compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. “Consisting essentially of” means that the embodiment comprises more than 50% of the identified components, preferably at least 75% of the identified components, more preferably at least 85% of the identified components, most preferably at least 95% of the identified components, for example at least 99% of the identified components. A composition “rich” in a component means that the composition consists essentially of the component.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

All percentages expressed herein are by weight of the total weight of the composition unless expressed otherwise. As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The terms “pet” and “animal” are used synonymously herein and mean any animal which can use a litter box, non-limiting examples of which include a cat, a dog, a rat, a ferret, a hamster, a rabbit, an iguana, a pig or a bird. The pet can be any suitable animal, and the present disclosure is not limited to a specific pet animal. The term “elimination” means urination and/or defecation by a pet.

As used herein, the term “litter” means any substance that can absorb animal urine and/or decrease odor from animal urine and/or feces. A “clumping litter” forms aggregates in the presence of moisture, the aggregates distinct from the other litter in the litter box. A “non-clumping litter” does not form distinct aggregates.

The term “litter box” means any apparatus that can hold pet litter, for example a container with a bottom wall and one or more side walls, and/or any apparatus configured for litter to be positioned thereon, for example a mat or a grate. As a non-limiting example, a litter box may be a rectangular box having side walls that have a height of at least about six inches.

The term “mesh” is defined by the ASTM E-11 U.S.A. standard specification for sieves. As used herein, “size” of a particle refers to the length of the longest dimension of the particle.

The methods and devices and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, the preferred devices, methods, articles of manufacture, or other means or materials are described herein.

An aspect of the present disclosure is a method of making a clumping pet litter. Another aspect of the present disclosure is a method of preventing or mitigating discoloration of a clumping pet litter. The methods can comprise coating clay particles with bentonite; and adding a chelating agent to the clay particles before the coating thereof with the bentonite and/or adding a chelating agent to the bentonite before the coating of the clay particles with the bentonite. Preferably, before the coating of the clay particles with the bentonite, the clay particles are subjected to sizing using a sieve to obtain a subset of particles that have a desired size, for example about −10 mesh to about +50 mesh.

The chelating agent can be added to the clay particles in a composition that is a solution or a dry powder. Alternatively or additionally, the chelating agent can be added to the bentonite before the coating of the clay particles with the bentonite. For example, in various embodiments the entirety of the chelating agent can be added to the clay particles before the coating thereof with the bentonite; the entirety of the chelating agent can be added to the bentonite before the coating of the clay particles with the bentonite; or a portion of the chelating agent can be added to the clay particles before the coating thereof with the bentonite, and the remaining portion of the chelating agent can be added to the bentonite before the coating of the clay particles with the bentonite. If the chelating agent is applied in a solution and the desired amount of the chelating agent exceeds the dissolution limit of the chelating agent, the portion of the chelating agent in excess of the dissolvable amount can be added to the clay particles as a fine powder, and then the dissolvable portion of the chelating agent can be spread onto the clay particles as a solution (e.g., a solution containing both the bentonite and the dissolvable portion of the chelating agent).

Preferably the chelating agent is uniformly applied to the particles. In this regard, the resultant particles should have an approximately consistent concentration of the chelating agent throughout the surface of the particles. For example, if the chelating agent is mixed with the bentonite before the coating of the clay particles, the composition comprising the bentonite and the chelating agent should be homogeneous before the clay particles are coated with it. To ensure uniform application of the chelating agent, some embodiments of the methods disclosed herein include grinding granules of the chelating agent into fine powders before adding the chelating agent to the clay particles and/or the bentonite.

Non-limiting examples of suitable clays include non-swelling clays, swelling clays, and combinations thereof. The clays can be obtained directly by mining natural clay deposits, can be synthetic clays, and/or can be clays that are derived from the agglomeration of clay particles, e.g., clay particles produced by litter or other manufacturing processes that involve the use of clays. The clay particles preferably contain about 20 wt. % to about 40 wt. % water, such as about 30 wt. % water.

Non-limiting examples of suitable non-swelling clays include kaolinites, illites, ventriculites, attapulgites, sepiolites, and non-swelling smectites. In preferred embodiments, the non-swelling clays are rich in the following clay minerals: palygorskite-sepiolite, kaolinite, dickite, nacrite, illite, glauconite, celadonite, and phengite. Most preferably, the non-swelling clays comprise the clay minerals Ca-montmorillonite, kaolinite, and illite.

Non-limiting examples of suitable swelling clays include smectites and swelling forms of kaolinites, illites, and vermiculites. In preferred embodiments, the swelling clays contain one or more of hectorite, beidelite, montmorillonite, nontronite, saponite, sauconite, vermiculite, and halloysite. In various embodiments, the swelling clays comprise Na-montmorillonite, hectorite, and vermiculite.

When used in combination, the non-swelling and swelling clays can be mixed in any amount suitable for forming the animal litters. Generally, the non-swelling and swelling clays can be mixed in amounts from about 10 to about 90 wt. % non-swelling clay and from about 90 to about 10 wt. % swelling clay.

The clay seed will typically include at least one clay that is not bentonite, but nevertheless in some embodiments the pet litter can be bentonite coated with additional bentonite.

Preferably sodium bentonite powder is utilized to coat the particles, for example a blend of sodium bentonite and guar gum. The powder can have a size of about 100 mesh to about 300 mesh, such as about 200 mesh. The coating comprising bentonite can further comprise an odor control agent and/or an anti-microbial agent. Preferably the bentonite in the coating is about 20 to about 40 wt. %, more preferably about 25 to about 35 wt. %, most preferably about 28 wt. % of the coated particles.

Generally, bentonite is a naturally occurring combination of clay minerals and some non-clay mineral constituents. Bentonite is rich in montmorillonite but may also include other clay and some non-clay mineral constituents. For example, bentonite can include trace amounts of minerals other than montmorillonite, for example feldspar, quartz, calcite, and/or gypsum. Non-limiting examples of devices that can be utilized to coat the particles with the bentonite include a fluidized bed dryer, a semi-continuous centrifugal coater, and a rotary coating and drying system.

In an embodiment, the clay particles and/or the composition comprising the bentonite consist of natural components only and thus do not contain non-naturally occurring components.

The chelating agent is preferably 0.01-5.0 wt. % of the coated particles, preferably 0.03-1.0 wt. % of the coated particles, preferably 0.05-1.0 wt. % of the coated particles. Non-limiting examples of suitable chelating agents include (i) sodium or potassium polyphosphates such as sodium tripolyphosphate, sodium pyrophosphate, sodium tetrapolyphosphate, sodium pentapolyphosphate, sodium hexapolyphosphate, and sodium hexametaphosphates; (ii) ethylenediaminetetraacetic acid (EDTA), diethylenetriaminepentaacetic acid, trimethylaminetricarboxylic acid, N(Hydroxyethyl) ethylenediaminetriacetic acid, nitrilotriacetic acid, and salts thereof; (iii) sodium citrates, potassium citrates, hytic acid, and salts thereof; (iv) malic acid and salts thereof; (v) succinic acid and salts thereof; (vi) tartaric acid and salts thereof; and (vii) combinations thereof. Preferred chelating agents are sodium tripolyphosphate (STPP), sodium pyrophosphate, ethylenediaminetetraacetic acid monosodium salt, ethylenediaminetetraacetic acid disodium salt, ethylenediaminetetraacetic acid trisodium salt, ethylenediaminetetraacetic acid tetrasodium salt, ethylenediaminetetraacetic acid monopotassium salt, ethylenediaminetetraacetic acid dipotassium salt, ethylenediaminetetraacetic acid tripotassium salt, ethylenediaminetetraacetic acid tetrapotassium salt, and combinations thereof. Most preferably the chelating agent comprises sodium tripolyphosphate (STPP).

In some embodiments, the clay particles are heated no more than about +300° C. before they are coated with the bentonite, preferably heated no more than about +150° C. before they are coated with the bentonite, and most preferably are not heated at all before they are coated with the bentonite. For example, the clay particles may be maintained at ambient temperature, i.e., 20 to 24° C., from the beginning of the method until at least a time after the coating with the bentonite. After the coating with the bentonite, heat may be applied to dry the coated particles to a moisture content from about 5 wt. % to about 15 wt. %, such as about 8 wt. %, to form the clumping pet litter. For example, the coated particles may be dried at a temperature of about 300° to about 400° Fahrenheit.

In a preferred embodiment, the clay particles are not agglomerated. For example, the clay particles may be coated with the bentonite while approximately having their original size, and in embodiments where the optional sizing and or compacting/sizing step is performed, may be coated with the bentonite while having approximately the size obtained by the sizing. As another example, in some embodiments the clay particles do not have any added water before they are coated with the bentonite.

In some embodiments, the pet litter further comprises an additive selected from the group consisting of an odor control agent, a fragrance, an anti-microbial agent, an anti-sticking agent, an agent for controlling pH, a dye, a coloring agent, a de-dusting agent, a disinfectant, and combinations thereof. The additive can be added at any stage.

Another aspect of the present disclosure is a package comprising a container containing any embodiment of the pet litter disclosed herein. Non-limiting examples of suitable containers include bags, boxes, cartons, bottles, packages of any type or design or material, over-wrap, shrink-wrap, affixed components (e.g., stapled, adhered, or the like), and combinations thereof.

Yet another aspect of the present disclosure is a method of managing pet waste (e.g., cat urine), the method comprising positioning any embodiment of the pet litter disclosed herein in a litter box. Preferably the litter box is located at a venue where a pet performs elimination, such as a home of the pet.

### EXAMPLE

The following non-limiting examples are illustrative of embodiments of the pet litters provided by the present disclosure and advantages thereof.

### Example 1

The present inventors used several methods to identify the root causes of discoloration in engineered litter (i.e., clay coated with bentonite). An elemental test of raw clay found that raw clay has roughly 15,000 part per million (ppm) iron and roughly 600 ppm manganese. XPS (X-ray photoelectron spectroscopy) analysis was used to study the surface properties of litter. XPS did not find any agglomeration of manganese in freshly-made engineered litter using raw clay as core seeds. On the other hand, the discolored spots on litter surface were shown to be agglomerated manganese, very likely manganese dioxide. Even though the clay contains more iron than manganese, surface agglomeration of iron was not found on engineered litter before or after exposing to air.

The following tests were also conducted for engineered litter using raw clay as core seeds:

(1) Fresh litter sample prepared using raw clay as seeds is put into a sealed jar→no discoloration

(2) Fresh litter sample prepared using raw clay as seeds is put into a sealed jar, also add small cup holding water in the jar such that saturated moisture is available in the sealed jar→no discoloration

(3) Dry the fresh litter sample prepared using raw clay as seeds in oven at 110° C. overnight, then expose the sample to air. Discoloration was almost totally stopped, but discoloration still occurs after exposing to air for over one month, just in a much minor scale.

(4) Fresh sample prepared using raw clay as seeds is put into a small pan exposing to air→litter discolored after about 1 week. The discoloration normally only appears on litter surface exposing to air.

The present inventors thus believe, without being bound to theory, that discoloration of engineered litter is probably caused by small amount of manganese, which migrates and is catalyzed on surface of litter after exposing to air.

### Example 2

A series of trials was conducted to test the effectiveness of a chelating agent in pet litter. Sodium tripolyphosphate (STPP) was used as a representative chelating agent, but other polyphosphates should work as well, such that the results can be extrapolated to other polyphosphates.

TABLE 1
Summary of Experiments

| | | | Addition | |
|---|---|---|---|---|
| | | | level | Effectively |
| Experiment | | Format of | (wt. % vs | mitigate or stop |
| No. | Litter Sample | addition | raw clay) | discoloration? |
| #0 | No STPP in litter (control, | | | |
| | raw clay as core) | | | |
| #1 | 1 wt. % STPP in raw clay | Powder & liquid | 1 wt. % | Yes |
| #2 | 1 wt. % STPP in raw clay | Powder & liquid | 1 wt. % | Yes |
| #3 | 0.5 wt. % STPP in raw clay | Powder & liquid | 0.5 wt. % | Yes |
| #4 | 0.25 wt. % STPP in raw clay | liquid | 0.25 wt. % | No, but slows |
| | | | | discoloration |
| #5 | 1 wt. % STPP dry-mixed with | dry mix with | 1 wt. % | Yes |
| | bentonite* | bentonite | | |
| #6 | 0.25 wt. % STPP dry-mixed | dry mix with | 0.25 wt. % | Yes |
| | with bentonite* | bentonite | | |
| #7 | 0.125 wt. % STPP dry-mixed | dry mix with | 0.125 wt. % | Yes |
| | with bentonite* | bentonite | | |

*In each example, specified amount of STPP was either added to raw clay seeds or dry mixed with bentonite before coating bentonite onto the raw clay cores.

The raw clay contained approximately 30 wt. % water. When adding STPP to raw clay seeds in the form of a solution, the STPP solution was sprayed uniformly onto the raw clay seeds. The moisture level in the raw clay was thus increased to 33-35 wt. % due to the added water.

The STPP solution or powder was spread as uniformly as possible. For example, when the STPP was added as powder, the STPP granules were first ground to fine powders.

It was found that STPP can effectively stop or mitigate discoloration once the STPP concentration reaches a specific level. In these tests, this level was 0.25 wt. % STPP vs. wet raw clay cores when STPP was added into raw clay. This threshold could change depending on the source of the raw clay. The working mechanism is still the same.

It was also found that STPP additive did not significantly change the litter clumping or odor control performance. Compared to control samples prepared with raw clay as the core, addition of STPP actually slightly increased cohesion strength when tested at 15 minutes.

The following table (Table 2) shows the color change observations for these tests. STPP in bentonite performed equally as well as adding STPP into the raw clay core, if not better. When adding STPP in bentonite, the STPP was added by dry mixing the two materials together.

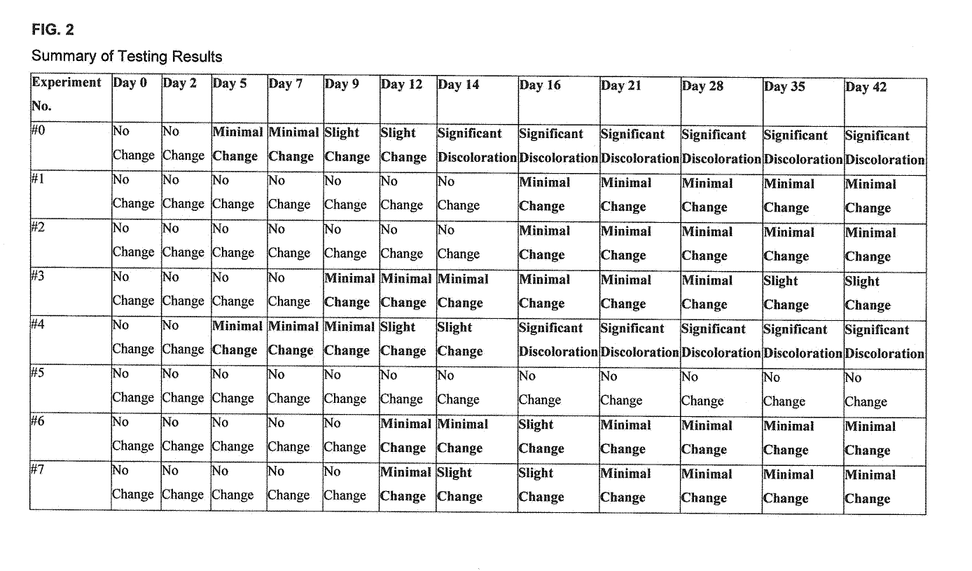

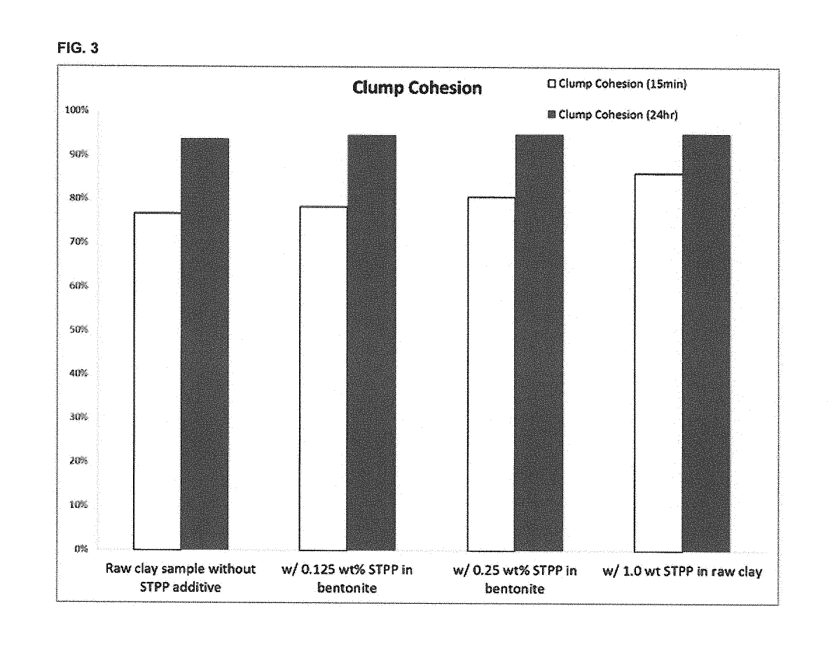

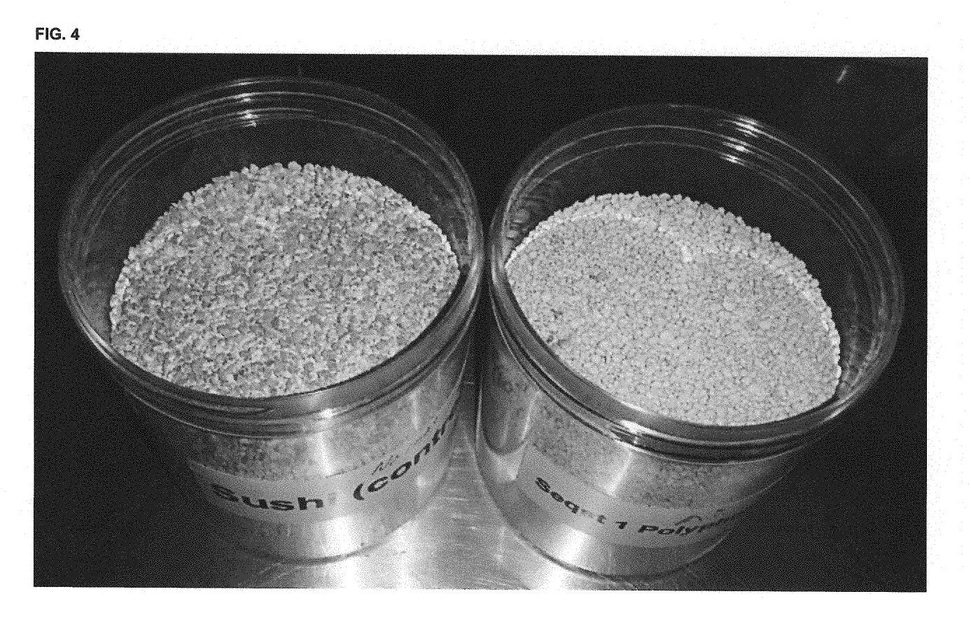

The Percentage of Cohesion values for all clumps were averaged, and the results are shown as FIGS. 2 and 3. The Percentage of Cohesion values for the tested pet litter were comparable to that of the current clay litter. FIG. 4 shows photographs of negative control litter which is discolored (left panel) and a litter sample with STPP as an additive, which has maintained color after four months of exposure to air (right panel).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of making a clumping pet litter, the method comprising:
coating clay particles with bentonite; and
incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.

2. The method of claim 1, comprising subjecting the clay particles to a sieve to obtain a subset of clay particles that have a desired size before the coating of the clay particles, and only the subset of clay particles is coated with the bentonite.

3. The method of claim 2, wherein the desired size is about −10 mesh to about +50 mesh.

4. The method of claim 1, wherein the chelating agent is 0.01-5.0 wt. % of the clay particles coated with the bentonite.

5. The method of claim 1, wherein the chelating agent is selected from the group consisting of sodium tripolyphosphate (STPP), sodium pyrophosphate, ethylenediaminetetraacetic acid monosodium salt, ethylenediaminetetraacetic acid disodium salt, ethylenediaminetetraacetic acid trisodium salt, ethylenediaminetetraacetic acid tetrasodium salt, ethylenediaminetetraacetic acid monopotassium salt, ethylenediaminetetraacetic acid dipotassium salt, ethylenediaminetetraacetic acid tripotassium salt, ethylenediaminetetraacetic acid tetrapotassium salt, and combinations thereof.

6. The method of claim 1, wherein the chelating agent comprises sodium tripolyphosphate (STPP).

7. The method of claim 1, wherein at least a portion of the chelating agent is added to the clay particles before the coating of the clay particles with the bentonite.

8. The method of claim 7, wherein the chelating agent added to the clay particles is uniformly applied to the clay particles.

9. The method of claim 1, wherein at least a portion of the chelating agent is added to the bentonite before the coating of the clay particles with the bentonite.

10. The method of claim 9, wherein the chelating agent added to the bentonite is uniformly mixed with the bentonite.

11. The method of claim 1, comprising drying the clay particles coated with the bentonite to a moisture content of about 5 wt. % to about 15 wt. %.

12. The method of claim 11, wherein the clay particles are not heated before the drying.

13. The method of claim 1, wherein the clay particles are not re-agglomerated before the coating with the bentonite.

14. The method of claim 1, comprising grinding granules of the chelating agent to reduce the size thereof before adding the chelating agent to the clay particles and/or the bentonite.

15. The method of claim 1, wherein the coating of the clay particles with the bentonite is performed by a device selected from the group consisting of a fluidized bed dryer, a semi-continuous centrifugal coater, a rotary coating and drying system, and combinations thereof.

16. A pet litter made by a process comprising coating clay particles with bentonite and comprising incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.

17. The pet litter of claim 16, further comprising an additive selected from the group consisting of an odor control agent, a fragrance, an anti-microbial agent, an anti-sticking agent, an agent for controlling pH, a dye, a coloring agent, a de-dusting agent, a disinfectant, and combinations thereof.

18. A method of managing pet waste, the method comprising positioning a pet litter in a litter box used by a pet, the pet litter made by a process comprising coating clay particles with bentonite and comprising incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.

19. The method of claim 18, wherein the pet is a cat.

20. A method of preventing or mitigating discoloration of a clumping pet litter, the method comprising:
coating clay particles with bentonite; and
incorporating a chelating agent into the pet litter by (i) adding at least a portion of the chelating agent to the clay particles before the coating thereof with the bentonite and/or (ii) adding at least a portion of the chelating agent to the bentonite before the coating of the clay particles with the bentonite.
